(19) United States
(12) Patent Application Publication
(10) Pub. No.: US 2003/0079175 A1
(43) Pub. Date: Apr. 24, 2003

(54) Data processing system and development tool

(75) Inventor: Alexei K. Limantsev, Moscow (RU)

Correspondence Address: G.E. EHRLICH (1995) LTD., c/o ANTHONY CASTORINA, SUITE 207, 2001 JEFFERSON DAVIS HIGHWAY, ARLINGTON, VA, 22202, US

(73) Assignee: Netlink I.T. Solutions Ltd.

(21) Appl. No.: 09/987,539

(22) Filed: Nov. 15, 2001

(30) Foreign Application Priority Data
Oct. 24, 2001 (IL) 146136

(51) Int. Cl. G06F 15/00

(52) U.S. Cl. 715/500

(57) ABSTRACT

A development tool for a network based data processing system comprises a document type developer for assembling document types from prestored object components and for associating a set of states with each document type. Each state defines at least one document property. The document types are used to instantiate documents to form a data processing system, and to provide the data processing system with state assignment functionality. The data processing system assigns each instantiation a succession of states, where each state is taken from the instantiation's set of states, thus applying the state's respective property to the instantiation. A succession of properties is thereby defined for the document type instantiation over the instantiation's life cycle.

### FIELD OF THE INVENTION

The present invention relates to a data processing system and more particularly but not exclusively to a development tool for a data processing system.

### BACKGROUND OF THE INVENTION

Successful development of data processing systems, such as those utilized by business and information technology applications, requires quick development times to take advantage of arising business opportunities and rapidly changing business conditions. After initial development, these applications must be easily maintained and updated. Many projects in this field become out-of-date before they reach the production stage.

In order to overcome this tendency, the approach to software development has been changing. Advanced methodologies based on an iterative approach to the development process are arising. The new methodologies are based upon basic services of increasing sophistication, such as web, application, and database servers. These services form a basis for creating the platforms for realizing advanced, highly productive applications. Various specialized tools for product development for these servers exist. These are usually conversion tools, compilation tools, tools for visual modeling and design, components, and object and procedure libraries for accessing the application server functions. Software component re-use is increasing, however few libraries of prepared component objects for a specific application field are available. Even in the cases where off-the-shelf libraries do include components for realizing low-level access to the functions of a specific application server, programmers either have to write a large amount of code realizing the logic of the application being developed or they have to use a fixed set of provided components that realize the logic, but only for a strictly defined application field. Both cases may require a complex development process to create an entire software system.

There is a shortage of means enabling application developers to utilize these platforms to achieve fast and effective development of data processing systems. Along with the growing capabilities provided by such platforms, they are becoming more complicated. For example, n-tier architecture applications, as well as the system services on which these applications are based, require rather complicated programming. Rapid development of n-tier architecture applications generally requires specialized development tools, convenient interfaces built into the application servers for managing the implementation environment, and an internal object model of services.

A significant consideration during application development is to provide a uniform concept for the internal structure of the application. For example, all objects whose state must be kept in a database (persistent state) must have defined methods of reading, saving and deleting, and these methods should have the same name and set of arguments. Business logic procedures should be separated from the storage access procedures, and the rules for the relationships between these two levels determined by clearly defined interfaces. The main disadvantage of the existing solutions is the lack of means developing the object models for data management.

A current development methodology to application development entitled workflow management is based on a two-level programming paradigm. Application data and the actions to be performed on this data are modeled and programmed separately. Application data is managed by a data management system, while business processes are handled by a workflow management system (WFMS).

In WFMS the definition and execution of the appropriate control and data flow, the assignment of people to tasks, and the invocation of the application logic blocks are externalized. Changes to the process are done without impacting the application logic blocks. A workflow-based application consists of a model of the underlying business process and a set of application logic blocks. The data underlying these logic applications is modeled and managed separately by a separate tool.

A single tool providing functionality to model both the data and the data processing and flow in a data-processing system is needed. A tool based on component reuse would enable quick development times for a variety of platforms. The development tool should facilitate tailoring of existing object component to a specific application field.

### SUMMARY OF THE INVENTION

According to a first aspect of the present invention there is thus provided a development tool for a network based data processing system, the tool comprising a document type developer for assembling document types from prestored object components and associating with each document type a set of states. Each state is definitive of at least one document property, and the document types are usable to instantiate documents to form a data processing system, and to provide the data processing system with state assignment functionality, for assigning to each instantiation successive ones of the set of states. Thus the respective property is applied to the instantiation, to thereby successively define for the document type instantiation within the data processing system a succession of properties during a life cycle of the document type instantiation.

In a preferred embodiment, each successive state implementation comprises a stage in the document life cycle, and the set of states includes at least one non-persistent state for attributing to document type instantiation stages that are not to be saved within the data processing system.

In a further preferred embodiment, the at least one non-persistent state is attributable to a document type instantiation outgoing stage.

In a further preferred embodiment, a persistent state is alternately attributable to a document type instantiation outgoing stage that is to be saved within the data processing system.

In a further preferred embodiment, the persistent state is effective to cause generation of the outgoing stage to be delayed.

In a preferred embodiment, the delay is set to depend on system load.

In a further preferred embodiment, the set of states includes at least one initiating state for assigning to a document type instantiation during creation of the document type instantiation.

In a further preferred embodiment, a document type instantiation comprises a document type indicator for indicating a document type of the instantiation.

In a further preferred embodiment, the development tool is operable to set for each data processing system a feature of placing the document type indicator in a document header.

In a preferred embodiment, at least one of the states has a property of check-in check-out control, thereby to restrict editing level access to a single user at any one time.

In a further preferred embodiment, the check-in check-out control comprises a time limitation for any given user.

In a further preferred embodiment, the development tool is operable to set for each data processing system a feature of prompting for saving document history each time an instantiation of a document type is assigned another one of the states.

In a further preferred embodiment, the development tool is operable to set for a document type a feature of saving document history each time an instantiation of the document type is assigned another one of the states.

In a further preferred embodiment, the development tool is operable to set for a document type instantiation a feature of saving document history each time the document type instantiation is assigned another one of the states.

In a preferred embodiment, the development tool is comprises owner allocation functionality for allocating an owner to each document type instantiation.

In a further preferred embodiment, owner allocation functionality is operable to set for each data processing system a feature of placing an indication of the allocated owner in a document header.

In a preferred embodiment, the development tool comprises global document identification functionality operable to set for each data processing system a feature of allocating to each document type instantiation a unique global identifier.

In a further preferred embodiment, the development tool the global document identification feature comprises functionality to place the unique global identifier for each document type instantiation in a document header.

In a preferred embodiment, the development tool comprises current state indication functionality operable to set for each data processing system a feature of placing a current one of the set of states of a document type instantiation in a document header.

In a further preferred embodiment, the development tool comprises state ordering functionality operable to set for at least one document type a defined order of succession amongst the set of states.

In a preferred embodiment, the state assignment functionality is operable to depend upon external input to an instantiation of a document type.

In a further preferred embodiment, the state assignment functionality is operable to depend upon a property of a document type instantiation.

In a further preferred embodiment, the state assignment functionality is operable to alter a property of a document type instantiation.

In a preferred embodiment, a document security property is definable via the states.

In a preferred embodiment, each successive state implementation comprises a stage in the document life cycle, and the document security property comprises a requirement for a document type instantiation to acquire at least one digital signature when passing through at least one predetermined stage.

In a preferred embodiment, the digital signature is acquirable from a user.

In a further preferred embodiment, the digital signature is acquirable from the data processing system.

In a preferred embodiment, each successive state implementation comprises a stage in the document life cycle, and the document security property comprises a requirement for a document type instantiation to have at least one digital signature from a previous stage before being assigned a state attributable to a new stage.

In a further preferred embodiment, the digital signature is acquirable from a user.

In a further preferred embodiment, the digital signature is acquirable from the data processing system.

In a preferred embodiment, the document type developer is operable to provide functionality for defining the security property at a document type level.

In a preferred embodiment, the properties definable via the states comprise document access permission.

In a further preferred embodiment, the owner is exchangeable with a change in state.

In a further preferred embodiment, the properties definable via the states comprise document access permission.

In a preferred embodiment, document access permission is definable for a given user.

In a further preferred embodiment, the access comprises deleting a document type instantiation.

In a further preferred embodiment, the access comprises reading a document type instantiation.

In a further preferred embodiment, the access comprises changing a property of a document type instantiation. In a preferred embodiment, a component protocol is one of a group of protocols comprising: ActiveX, COM, and COM+.

According to a second aspect of the present invention there is thus provided a network based data processing system for processing data arranged in documents. The documents are instantiations of document types obtained from a document type library. The document types have a set of states, wherein each state is definitive of at least one document property. The data processing system has state assignment functionality for assigning to each document successive ones of the set of states and thus applying the respective property to the instantiation, to thereby successively define for each document within the data processing system a succession of properties during a life cycle of the document.

In a preferred embodiment, each of the document types comprises an assembly of predefined object components.

In a preferred embodiment, the data processing system comprises document type addition functionality for adding a document type to the document type library during data processing system operation.

In a further preferred embodiment, each successive state implementation comprises a stage in the document life cycle, and the set of states includes at least one non-persistent state for attributing to document stages that are not to be saved within the data processing system.

In a further preferred embodiment, the at least one non-persistent state is attributable to a document outgoing stage.

In a preferred embodiment, a persistent state is alternately attributable to a document outgoing stage that is to be saved within the data processing system.

In a further preferred embodiment, the persistent state is effective to cause generation of the outgoing stage to be delayed.

In a further preferred embodiment, the delay is set to depend on system load.

In a preferred embodiment, the set of states includes at least one initiating state for assigning to a document during creation of the document.

In a preferred embodiment, the data processing system is operable to place a document type indicator in a document header.

In a preferred embodiment, at least one of the states has a property of check-in check-out control, to restrict editing level access to a single user at any one time.

In a further preferred embodiment, the data processing system the check-in check-out control comprises a time limitation for any given user.

In a preferred embodiment, the data processing system is operable to set for each data processing system a feature of prompting for saving document history each time any document is assigned another one of the states.

In a further preferred embodiment, the data processing system is operable to set for a document type a feature of saving document history each time an instantiation of the document type is assigned another one of the states.

In a further preferred embodiment, the data processing system is operable to set for a document a feature of saving document history each time the document is assigned another one of the states.

In a preferred embodiment, the data processing system comprises owner allocation functionality for allocating an owner to each document.

In a further preferred embodiment, the owner allocation functionality is operable to set a feature of placing an indication of the allocated owner in a document header.

In a further preferred embodiment, the data processing system comprises global document identification functionality operable to set a feature of allocating to each document a unique global identifier.

In a further preferred embodiment, the global document identification feature is operable to place the unique global identifier for each document in a document header.

In a further preferred embodiment, the data processing system comprises current state indication functionality for setting a feature of placing a current one of the set of states of a document in a document header.

In a preferred embodiment, the data processing system comprises state ordering functionality for setting for at least one document type a defined order of succession amongst the set of states.

In a further preferred embodiment, the state assignment functionality is operable to accept external input to affect assignment of the states.

In a further preferred embodiment, the state assignment functionality is operable to affect assignment of the states in accordance with a property of a document.

In a further preferred embodiment, the state assignment functionality is operable to alter a property of a document.

In a preferred embodiment, a document security property is definable via the states.

In a preferred embodiment, each successive state implementation comprises a stage in the document life cycle, and the document security property comprises a requirement for a document to acquire at least one digital signature when passing through at least one predetermined stage.

In a further preferred embodiment, the digital signature is acquirable from a user.

In a further preferred embodiment, the digital signature is acquirable from the data processing system.

In a preferred embodiment, each successive state implementation comprises a stage in the document life cycle, and the document security property comprises a requirement for a document to have at least one digital signature from a previous stage before being assigned a state corresponding to a new stage.

In a further preferred embodiment, the digital signature is acquirable from a user.

In a further preferred embodiment, the digital signature is acquirable from the data processing system.

In a further preferred embodiment, the data processing system is operable to provide functionality for defining the security property at a document type level.

In a preferred embodiment, a property definable via the states comprises document access permission.

In a further preferred embodiment, the owner is exchangeable with a change in state.

In a preferred embodiment, wherein a property definable via the states comprises document access permission In a further preferred embodiment, document access permission is definable for a given user. In a further preferred embodiment, the access permission comprises permission to delete a document. In a further preferred embodiment, the access permission comprises permission to read a document. In a further preferred embodiment, the access permission comprises permission to change a property of a document.

In a preferred embodiment, a document comprises a header for recording the type and state of the document, and a body for recording additional properties.

In a further preferred embodiment, a document further comprises a signature section for recording at least one digital signature.

In a further preferred embodiment, a document further comprises a history section for recording document history.

In a further preferred embodiment, a document further comprises a relationships section for recording at least one reference to another document.

In a preferred embodiment, a document is presented in one of a group of formats comprising: text, XML, SGML, HTML, dynamic HTML, and VRML.

In a preferred embodiment, the data processing system further comprises a kernel having functionality for providing access to the documents through a standard interface. In a further preferred embodiment, the kernel is operable to provide the access to the documents through the standard interface by receiving an external call to the document through the standard interface, determining a document type of the document, transforming the external call into a call appropriate to the document type, and forwarding the converted call to the document.

In a further preferred embodiment, a protocol of the external call to the kernel includes one of a group comprising: web service protocols, SOAP, DCOM, HTTP, and HTTPS.

In a further preferred embodiment, the data processing system further comprises a runtime environment having functionality for providing runtime services for controlling and monitoring the data processing system.

According to a third aspect of the present invention there is thus provided a method of providing a development tool for a network based data processing system, the method comprising: providing a component data store comprising a plurality of object components, and providing a document type developer for assembling document types from the object components and for associating with each a set of states. Each state is definitive of at least one document property. The document types are usable to instantiate documents to form a data processing system, and with a data processing system having state assignment functionality for assigning to each instantiation successive ones of the set of states and thus applying the respective property to the instantiation, to thereby successively define for the document type instantiation within the data processing system a succession of properties during a life cycle of the document type instantiation.

In a preferred embodiment, a protocol of an object component is one of a group of protocols comprising: ActiveX, COM, and COM+.

In a preferred embodiment, the method comprises the further step of providing a code inserter for attaching application specific code to the object components.

In a further preferred embodiment, providing a document type developer further comprises providing a code generator for generating application specific code from a set of data provided by a data processing system developer.

In a preferred embodiment, the code conforms to a coding standard.

In a further preferred embodiment, the code conforms to a naming convention.

According to a fourth aspect of the present invention there is thus provided a method of developing a data processing system, the method comprising: generating document types from prestored object components, and associating with each document type a set of states. Each state is definitive of at least one document property. The document types are usable to instantiate documents to form a data processing system having state assignment functionality for assigning to the document type instantiation successive ones of the set of states and thus applying the respective property to the document type instantiation, to thereby successively define for the document type instantiation within the data processing system a succession of properties during a life cycle of the document type instantiation.

In a preferred embodiment, assembling a document type from prestored object components comprises: inserting application specific code into an object component thereby creating an application component, and combining the application component with at least one other component thereby to form an application specific document type.

In a further preferred embodiment, assembling a document type further comprises: defining a set of transitions between pairs of states from the set of states, defining a set of transition rules comprising at least one transition rule for each of the transitions, the transition rule identifying a condition at which an instantiation of the document type undergoes the transition, and associating the set of transitions and the set of transition rules with the document type thereby to define a legal succession of properties during a life cycle of a document type instantiation.

In a preferred embodiment, the condition comprises receiving a predetermined external input to a document type instantiation.

In a further preferred embodiment, the condition comprises a property of a document type instantiation equaling a predetermined value.

In a preferred embodiment, defining the set of transition rules comprises defining an order of the set of states.

In a further preferred embodiment, each successive state implementation comprises a stage in the document life cycle, and a transition rule comprises a requirement for a document type instantiation to acquire at least one digital signature when passing through a respective stage.

In a further preferred embodiment, wherein the digital signature is acquirable from a user.

In a further preferred embodiment, the digital signature is acquirable from the data processing system.

In a preferred embodiment, each successive state implementation comprises a stage in the document life cycle, and the set of states includes at least one non-persistent state for attributing to document type instantiation stages that are not to be saved within the data processing system.

In a further preferred embodiment, the at least one non-persistent state is attributable to a document type instantiation outgoing stage.

In a preferred embodiment, a persistent state is alternately attributable to a document type instantiation outgoing stage that is to be saved within the data processing system.

In a further preferred embodiment, the persistent state is effective to cause generation of the outgoing stage to be delayed.

In a preferred embodiment, the delay is set to depend on system load.

According to a fifth aspect of the present invention there is thus provided a method of defining the processing of a document in a data processing system having state assignment functionality. The document comprises an instantiation of a document type, the document type having a set of states, each state being definitive of at least one document property, for assigning to the document successive ones of the set of states and thus applying the respective property to the document, to thereby successively define for the document a succession of properties during a life cycle of the document. The method comprises: defining a set of transitions between pairs of states from the set of states, defining a set of transition rules comprising at least one transition rule for each of the transitions, the transition rule identifying a condition at which an instantiation of the document type undergoes the transition, and associating the set of transitions and the set of transition rules with the document type.

In a preferred embodiment, the condition comprises an external input to a document type instantiation.

In a further preferred embodiment, the condition comprises a property of a document type instantiation.

In a preferred embodiment, defining a set of transition rules comprises defining an order of the set of states.

In a preferred embodiment, each successive state implementation comprises a stage in the document life cycle, and a transition rule comprises a requirement for a document type instantiation to acquire at least one digital signature when passing through a respective stage.

In a further preferred embodiment, the digital signature is acquirable from a user.

In a further preferred embodiment, the digital signature is acquirable from the data processing system.

In a preferred embodiment, each successive state implementation comprises a stage in the document life cycle, and the set of states includes at least one non-persistent state for assigning to document type instantiation stages that are not to be saved within the data processing system.

In a further preferred embodiment, the at least one non-persistent state is assignable to a document type instantiation outgoing stage.

In a further preferred embodiment, a persistent state is alternately assignable to a document type instantiation outgoing stage that is to be saved within the data processing system.

In a further preferred embodiment, the persistent state is effective to cause generation of the outgoing stage to be delayed.

In a further preferred embodiment, the method comprises the further step of providing external access to a document through a standard interface by: receiving a call to a document through the standard interface, determining a document type of the document, converting the external call into a call that uses a protocol appropriate to the document type, and forwarding the converted call to the document.

### BRIEF DESCRIPTION OF THE DRAWINGS

For a better understanding of the invention and to show how the same may be carried into effect, reference will now be made, purely by way of example, to the accompanying drawings, in which:

FIG. 1 shows a preferred embodiment of a development tool for a network based data processing system.

FIG. 2 shows a preferred embodiment of a network based data processing system having state assignment functionality.

FIG. 3 shows a preferred embodiment of a document for a network based data processing system as described above.

FIG. 4 is a simplified flow chart of an embodiment of a method for providing a development tool for a network based data processing system.

FIG. 5 is a simplified flow chart of an embodiment of a method for developing a network based data processing system.

FIG. 6 is a simplified flow chart of an embodiment of a method for assembling a document type from prestored object components.

FIG. 7 is a simplified flow chart of an additional embodiment of a method for assembling a document type.

FIG. 8 is a simplified flow chart of an embodiment of a method for defining the processing of a document in a data processing system having state assignment functionality.

FIG. 9 is a simplified flow chart of an embodiment of a method for providing external access to a document through a standard interface for documents of the data processing system having state assignment functionality.

### DESCRIPTION OF THE PREFERRED EMBODIMENTS

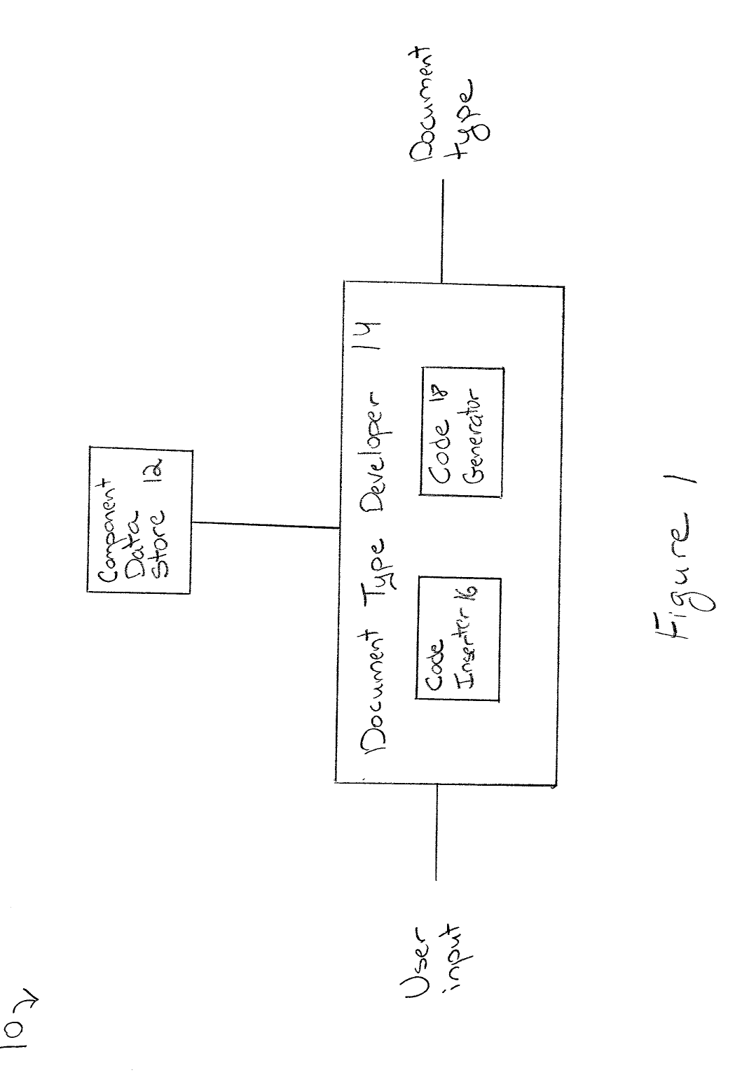

Reference is now made to FIG. 1, which shows a preferred embodiment of a development tool for a network based data processing system 10. The tool comprises a component data store 12 containing object components, and a document type developer 14 which assemblies document types from the object components and associates a set of states with each document type. The document types are used by a data processing system to generate documents, which are stored and processed by the data processing system. Document processing is dependent upon the document state, as described below. The development tool 10 further comprises code inserter 16 for attaching application specific code to a document type, and code generator 18 for generating application specific code from a set of data provided by a data processing system developer.

Development tool 10 is used to create a set of document types for use with a data processing system with state assignment functionality. The document types are used as templates which are instantiated to form the documents processed by the data processing system. A document type defines the properties and methods of each document instantiated from that document type. Each document type is associated with a set of states, each state defining at least one document property. Each state comprises a stage in the life cycle of a document. The document type developer 14 defines legal progressions of states for each document type, and the conditions under which a state transition occurs. The processing of a document type instantiation by the data processing system is dependent upon the current document state. During the document life cycle the document is assigned successive states, thereby creating an orderly succession of document properties. State succession for a given document may depend upon external input to that document, or upon the value of a document property. The data processing system can alter a document property during a document state transition.

The document type developer 14 can define a document type having document instantiations that do not undergo state transitions. A document type having such instantiations has a set of states comprising a single state only.

In the preferred embodiment the development tool 10 provides functionality to define some states as non-persistent. A non-persistent state is assigned to a document during a life cycle stage that is not to be saved within the data processing system. A document outgoing stage that does not need to be saved within the data processing system is assigned a non-persistent state, for example during the generation of a report that is not to be saved by the system. Alternately, an outgoing stage that is to be saved is assigned a persistent state. In the preferred embodiment, the data processing system can delay the generation of a persistent outgoing stage according to system load, to perform load balancing.

The preferred embodiment comprises a special initial state the document that is assigned to a document during document creation. A document is assigned this state only while it is being instantiated from a document type.

Development tool 10 provides functionality for defining for a document type several data processing system features which affect document processing. One data processing system feature which can be defined is for the data processing system to place a document type indicator in a document header. Each document in the data processing system is an instantiation of a particular document type. Processing of the document by the data processing system is dependent upon the document type. Placing an indication of the document type in a header of each document type provides a simple method for the data processing system to identify the document and thus manage document processing. Similarly the data processing system has a feature that causes an indicator of the current document state to be placed in the header. The development tool 10 can also set a data processing system feature causing the data processing system to generate a unique global identifier for each document type instantiation and place it in the document header to allow a given document to be identified uniquely, no matter what state it is in.

Additional preferred embodiments of development tool 10 set similar data processing system features, including document owner and user identification features. In the preferred embodiment each document in the data processing system is allocated an owner. The document owner is exchangeable during a change in document state. A document is also defined to have a user, who may differ from the document owner. The development tool 10 can set data processing system features causing the data processing system to place document owner and/or user indicators in the document header. Access and security rights to a given document can be defined for the document user and owner separately, and can be state dependent. Operations requiring access authorization include reading, deleting, and modifying a document.

Another data processing system feature that can be set by the development tool 10 is check-in check-out control. Setting this feature ensures that the data processing system restricts editing level access to a single user at any one time. This feature can have a time limit parameter that sets an access time limit for any given user. Setting a time limit for document check-out ensures that a user cannot block access to a document by omitting to check it back in after accessing the document.

The preferred embodiment of the development tool 10 provides functionality for setting a data processing system feature of prompting for saving document history each time any document type instantiation is assigned another states. A preferred embodiment of a document for a data processing system with history recording functionality contains a history section, which is used by the data processing system to record document history. In additional preferred embodiments a document history feature is set to record the history of instantiations of a particular document type or of a specific document.

The development tool 10 determines the access rules used by the data processing system to control document access. Document access authorization is provided according to document type, state, owner, and user. Document access authorization is required for a user to perform certain operations upon documents. These operations include reading, deleting, and modifying a document.

The development tool 10 comprises functionality for defining security properties used by the data processing system to monitor document security. A security property is definable at the document type or document type instantiation levels. In the preferred embodiment a security property is associated with a document type, owner, user and state. One such security property is for the data processing system to require a document to acquire one or more digital signatures during a particular state. A digital signature may be acquired from a user or from the data processing system. A document that does not have the signatures can be blocked from progressing to another state.

In the preferred application the component data store 12 contains a collection of reusable object components in a number of standard protocols such as ActiveX, COM, and COM+. The object components provide a framework of properties and methods. During data processing system development these properties and methods are implemented as required by the application. The code inserter 16 is used to insert application specific code into the object components. The implemented components are assembled into document types. In the preferred embodiment the generated code conforms to a coding standard and to naming conventions, for ease of code debugging and maintenance. The preferred embodiment further comprises a code generator 18 which generates the code inserted by the code inserter 16 from a description or set of data provided by the application developer.

In the preferred embodiment the document is presented in extended markup language (XML) format. XML enables describing documents of any structure without binding the document to the representation form, as well as content-independent definition of data representation form. The preferred embodiment uses a text formatting method and a text parsing method to export any object into a system-independent XML format, to save and retrieve the internal state of objects and electronic documents, and to perform free movement of electronic documents between platforms and systems of various types. It is possible to form complicated compound objects from less complicated ones by defining the object structure in an XML presentation, thereby enabling component reuse. Alternate preferred embodiments present the document in other formats, including: text, standard generalized markup Language (SGML), hypertext markup language (HTML), dynamic HTML, and virtual reality modeling language (VRML).

Development tool 10 is well suited to developing data processing systems implementing n-tier architecture. In a typical n-tier system, the first layer houses the database or centralized data stores; the second layer is where the programs and/or business logic is located, and the third layer is the client or data access layer. In a preferred embodiment, development tool 10 assembles a document type from three or more object components, where each layer of the n-tier system is implemented by an object component dedicated to that application layer. In the preferred embodiment a document type consists of an additional object component which encapsulates all the properties of that document type, and is responsible for presenting the document in the format used by the data processing system.

The preferred embodiment of the data processing system development tool has functionality to perform a wide variety of tasks. The development tool is used to define system users and user roles such as document access and signature rights. It provides functionality for describing the main objects of the data processing system, the documents, by defining the attributes and methods of the document types. A document type is realized as an assembly of object components, preferably COM components. The development tool code generator and code inserter automatically form application specific code and insert it into object components. The development tool additionally associates a set of states with each document type, and defines the document processing logic over the document life cycle. In a further preferred embodiment, the development tool is further operable to automatically form SQL scenarios by creating the tables for storage of each electronic document type and the SQL procedure for accessing this storage. The development tool further comprises a component data store containing object components. Additional features of a data processing system in accordance with the preferred embodiment of development tool 10 are described below.

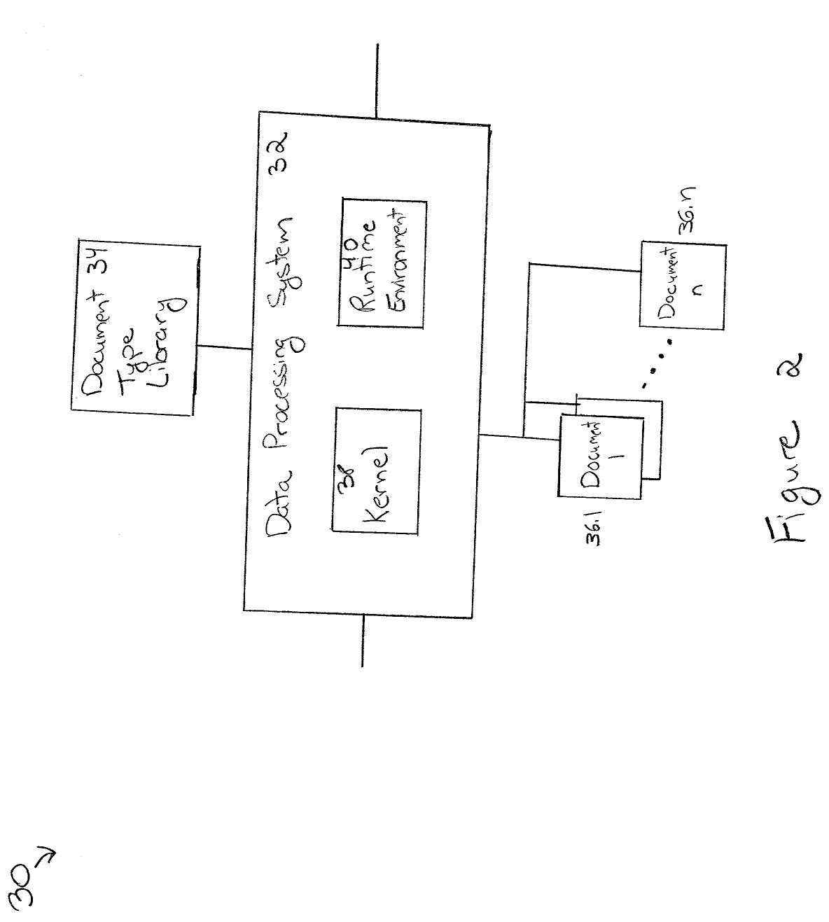

Reference is now made to FIG. 2, which shows a preferred embodiment of a network based data processing system 30 having state assignment functionality. Data processing system 30 comprises data processor 32, document type library 34, and documents 36.1 through 36.n. Data processor 32 performs all the data processing and comprises a kernel 38 which provides a standard interface for accessing documents 36, and runtime environment 40 which handles other document processing functions.

In the preferred embodiment the main objects of the data processing system 30 are documents, each of which is an instantiation of a predefined document type. Data processing system 30 is formed by generating a set of documents 36 from the document types contained in document type library 34. The document types are defined for the data processing system 30 by a development tool. Data processing system 30 provides functionality for adding document types to the system after initial system development. The life cycle of a document 36 is a progression of discrete stages, where each stage is associated with a state. Documents associated with a document type having a set of states comprising a single state do not undergo state transitions, but remain in a single state for the duration of document processing. Each document type has predefined rules which determine legitimate sequences of state progression. The state of the data processing system 30 changes according to the movement of the documents 36 from state to state. Transfer of an electronic document from one state to another is determined by fulfillment of rules specified for such transfer.

In the preferred embodiment, runtime environment 40 provides most data processing and document control services. Runtime environment 40 creates and deletes documents from the system, monitors document properties, and transfers documents from state to state when the conditions required for a state transition are fulfilled. Each transfer of an electronic document from state to state is monitored by runtime environment 40 security functionality, using the digital signature rules and other security rules. Runtime environment 40 additionally checks documents in and out, generates and attaches global identifiers to a document, and monitors user authorizations.

Kernel 38 provides access to documents 36 through a standard interface. In the preferred embodiment the kernel 38 is a set of component object model components, such as COM and Microsoft™ COM+ components, used for document access. Alternate preferred embodiments use other component protocols, such as ActiveX. The kernel 38 communicates with them through a predefined interface which is identical for documents of all types. External communication to the kernel 38 can be implemented in a variety of protocols, including web service protocols, simple object access protocol (SOAP), distributed component object model (DCOM), hypertext transfer protocol (HTTP), secured hypertext transfer protocol (HTTPS), and other distributed object and client-server protocols.

In the preferred embodiment, kernel 38 implements the standard interface by generating the communication object for a specific document in response to an external call to a document. When an external call is received, kernel 38 first extracts the document type from the document using the document type indicator is located in the document header. After the document type is determined, the external call is transformed into a call appropriate to the document type, and the converted call is forwarded to the document. Kernel 38 has no functionality for handling other application-dependent properties of a specific document type. These properties are handled only by components associated with the particular document type, and components of related document types. In the n-tier preferred embodiment, application specific properties are processed by business-logic and data access components for each document type.

A similar mechanism is employed by the runtime environment 40 to perform all other document management functions. In the preferred embodiment, where the document type is implemented as an assembly of COM and ActiveX components, there is a dedicated COM component that encapsulates all the properties of the specific document type and is responsible for presenting these properties in the appropriate format. The correspondence between document type and the components associated with the document type is described in a special document type reference list. When processing a document the runtime environment 40 determines the document's type from the document header. Referring to the document type and the reference list, the runtime environment 40 dynamically runs the additional components required by documents of that type during document processing. The system provides functionality for the dynamic addition of new document types to the data processing system, thus adding to the reference list.

In the preferred embodiment used for a data processing system 30 based on n-tier architecture, the components for processing business logic and data access are standard COM objects. The kernel 38 communicates with them through standard component interfaces, which are predefined and identical for processing objects of all the document types. After extracting the document type identifier from the document header, kernel 38 uses the document type definition to locate the business logic and database access processing objects. Using the processing objects, kernel 38 creates the appropriate objects which provide it with a pointer to the appropriate interface and then calls a required method from this interface.

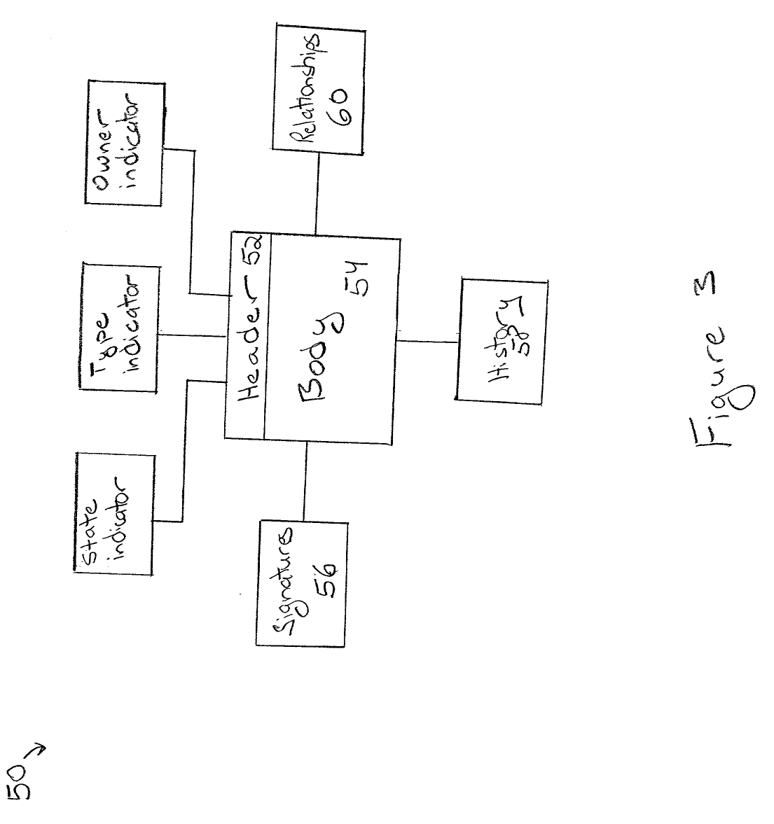

Reference is now made to FIG. 3, which shows a preferred embodiment of a document 50 for a network based data processing system as described above. The document comprises a header section 52, a body section 54, a signatures section 56, a history section 58, and a relationships section 60.

Header section 52 contains indicators of the document type, and current state. In an additional preferred embodiment it also includes owner and user indicators, as well as additional parameters. The header 52 plays a significant role during document creation and management, and for accessing the document through the standard interface.

Body section 54 contains application-dependent information for the document, as required for the application field. The body 54 can have a complex hierarchical structure as determined by specific business needs.

Signatures section 56 contains a document signature collection. The signature collection serves for document processing and security purposes. In the preferred embodiment, each element of the collection contains a digital signature key identifier, key name, digital signature image, and reference to a history section element to which this signature refers. The signature is based on the contents of the document body 54. Portions of the document for usage only are not signed, as they can change repeatedly during the document life cycle.

History section 58 contains a collection of records about document state transitions and operations performed on the document. In the preferred embodiment, each history element contains information about the time of the event, the document state at that time, the user or process that performed the event, and the server on which the event occurred. In an alternate preferred embodiment the history element additionally contains document version information.

Relationships section 60 contains a collection of references to other documents. In the preferred embodiment, each relationship element identifies a related document, and a relationship type. For example, a relationship element can serve to identify a document cancelled by the present document. In the preferred embodiment, a document is identified by its global identifier.

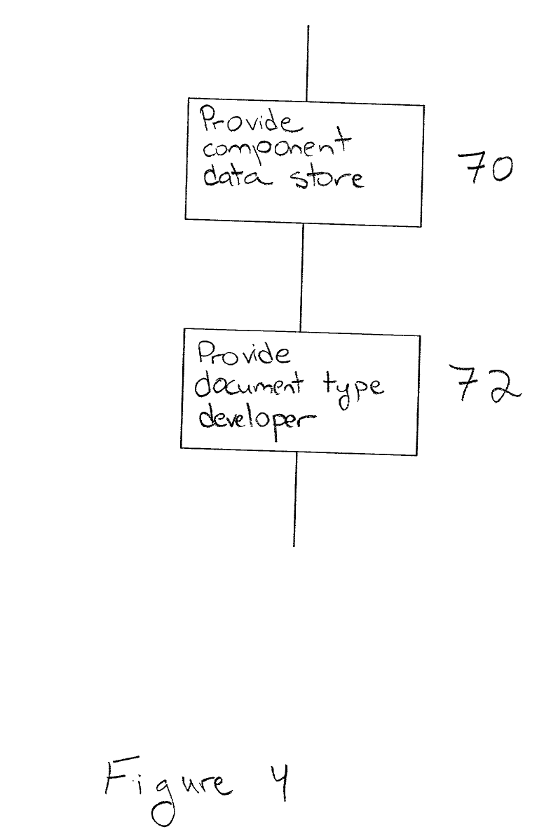

Reference is now made to FIG. 4, which is a simplified flow chart of an embodiment of a method for providing a development tool for a network based data processing system. In step 70 a component data store comprising a plurality of object components is provided. As described above these objects are used for generating document types. A document type developer for assembling document types from the object components and for associating each document type with a set of states is provided in step 72. In a preferred embodiment, a code inserter for attaching application specific code to a document type is also provided. In a further preferred embodiment a code generator for generating application specific code is provided as well. The code generator preferably functions as a wizard which generates the application code automatically from a set of data provided by a data processing system developer.

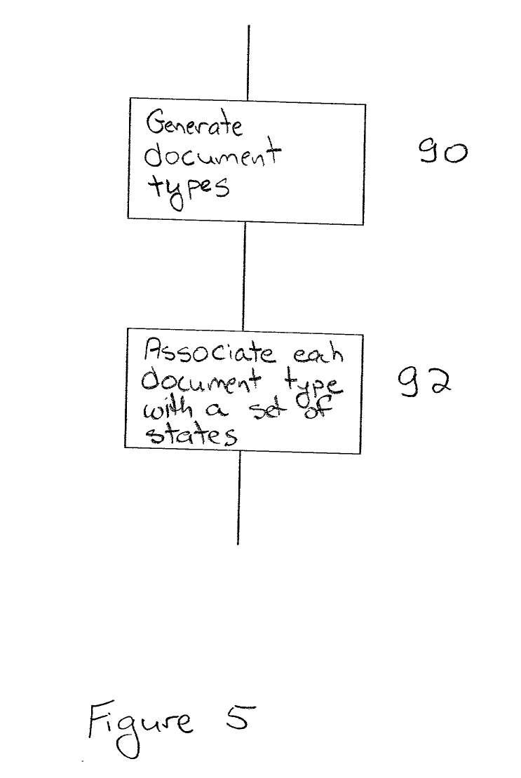

Reference is now made to FIG. 5, which is a simplified flow chart of an embodiment of a method for developing a network based data processing system. In step 90 document types are generated from prestored object components. After the document types are generated, each document type is associated with a set of states in step 92. Each state defines at least one document property. The document types are usable in a data processing system having state assignment functionality to instantiate documents.

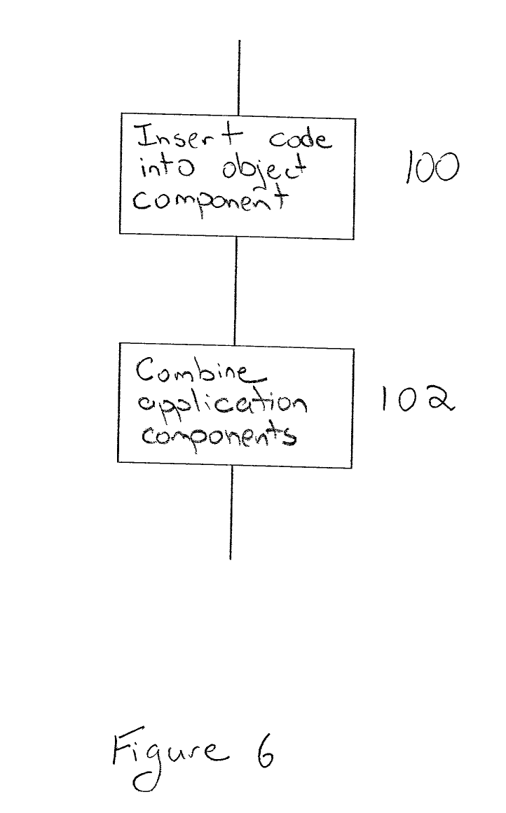

Reference is now made to FIG. 6, which is a simplified flow chart of an embodiment of a method for assembling a document type from prestored object components. Application specific code is inserted into an object component to create an application component in step 100. The application specific code implements the general methods of the object component to fulfill the requirements of the data processing application under development. The application components are combined in step 102 to form an application specific document type.

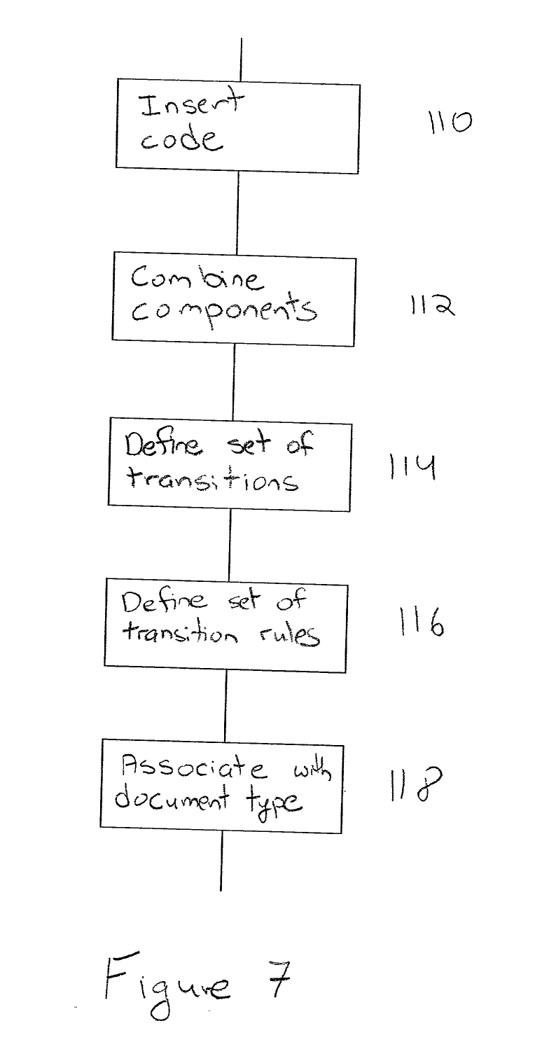

Reference is now made to FIG. 7, which is a simplified flow chart of an additional embodiment of a method for assembling a document type. As described above, application specific code is inserted into an object component to create an application component in step 110, and application components are combined in step 112 to form a document type. The method contains the following additional steps. In step 114 a set of transitions between pairs of states is defined from the set of states associated with the document type. Next, in step 116, a set of transition rules is defined. The transition rule set comprises at least one transition rule for each legal transition between states. A transition rule identifies a condition at which a document type instantiation undergoes the given transition. In step 118 the transitions and transition rules sets are associated with the document type being assembled. These transition rules serve to define a legal succession of properties during the life cycle of a document type instantiation.

The document type developer provides a tool for defining all the document properties and data processing system functionality of the embodiments described above. This functionality includes, but is not limited to, defining conditions that trigger document state transitions, signature and security system requirements for each document or document type, and establishing persistent states.

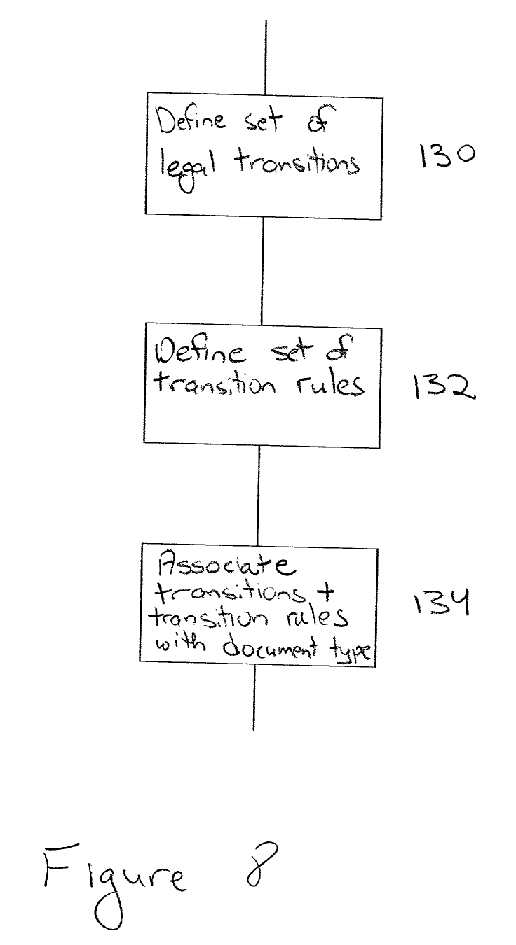

Reference is now made to FIG. 8, which is a simplified flow chart of an embodiment of a method for defining the processing of a document in a data processing system having state assignment functionality. Step 130 consists of defining a set of legal transitions between pairs of states from the set of states associated with a given document type. The set of transitions delimit the succession of document properties for a document instantiated from that document type by specifying legal progressions of the document from state to state. In step 132 a set of transition rules is defined, where each legal transition has at least one transition rule associated with it. The transition rule identifies a condition at which an instantiation of the given document type undergoes the transition. Finally, the transition and transition rules sets are associated with the document type in step 134. The transitions and transition rules provide a mechanism for defining aspects of document processing, including the effects of external inputs to the document, the effect of various document properties including digital signature and other security requirements, and persistent state definition.

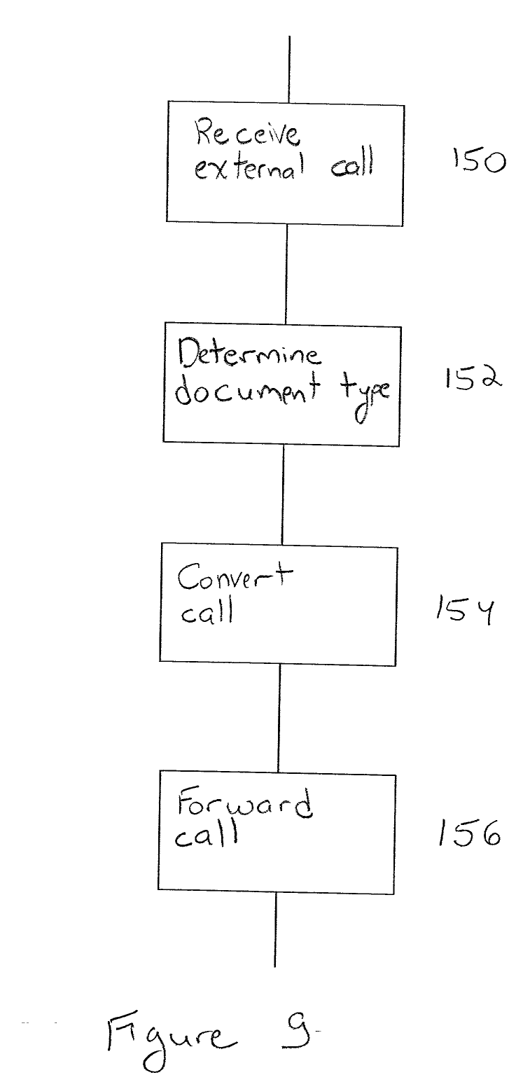

Reference is now made to FIG. 9, which is a simplified flow chart of an embodiment of a method for providing external access to a document through a standard interface for documents of the data processing system having state assignment functionality. First, a call to a document is received through the standard interface in step 150. The document type of the document is determined in step 152. In step 154 the external call is converted into a call in a protocol appropriate to the document type of the document the call is intended for. Finally, in step 156 the converted call is forwarded to the document in the protocol appropriate for the document.

The preferred embodiment described here is based on a Microsoft™ Windows operating system. Additional preferred embodiments utilize other operating systems including Linux, JAVA™, and DOS.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable subcombination.

It will be appreciated by persons skilled in the art that the present invention is not limited to what has been particularly shown and described hereinabove. Rather the scope of the present invention is defined by the appended claims and includes both combinations and subcombinations of the various features described hereinabove as well as variations and modifications thereof which would occur to persons skilled in the art upon reading the foregoing description.

We claim:

1. A development tool for a network based data processing system, the tool comprising a document type developer for assembling document types from prestored object components and associating with each document type a set of states, each state being definitive of at least one document property, said document types being usable to instantiate documents to form a data processing system, said document types being usable to provide said data processing system with state assignment functionality, for assigning to each instantiation successive ones of said set of states and thus applying said respective property to said instantiation, to thereby successively define for said document type instantiation within said data processing system a succession of properties during a life cycle of said document type instantiation.

2. A development tool according to claim 1, wherein each successive state implementation comprises a stage in said document life cycle, and wherein said set of states includes at least one non-persistent state for attributing to document type instantiation stages that are not to be saved within the data processing system.

3. A development tool according to claim 2, wherein said at least one non-persistent state is attributable to a document type instantiation outgoing stage.

4. A development tool according to claim 3, wherein a persistent state is alternately attributable to a document type instantiation outgoing stage that is to be saved within the data processing system.

5. A development tool according to claim 4, said persistent state being effective to cause generation of said outgoing stage to be delayed.

6. A development tool according to claim 5, wherein said delay is set to depend on system load.

7. A development tool according to claim 1, wherein said set of states includes at least one initiating state for assigning to a document type instantiation during creation of said document type instantiation.

8. A development tool according to claim 1, wherein a document type instantiation comprises a document type indicator for indicating a document type of said instantiation.

9. A development tool according to claim 8, operable to set for each data processing system a feature of placing said document type indicator in a document header.

10. A development tool according to claim 1, wherein at least one of said states has a property of check-in check-out control, thereby to restrict editing level access to a single user at any one time.

11. A development tool according to claim 10, wherein said check-in checkout control comprises a time limitation for any given user.

12. A development tool according to claim 1, operable to set for each data processing system a feature of prompting for saving document history each time an instantiation of a document type is assigned another one of said states.

13. A development tool according to claim 1, operable to set for a document type a feature of saving document history each time an instantiation of said document type is assigned another one of said states.

14. A development tool according to claim 1, operable to set for a document type instantiation a feature of saving document history each time said document type instantiation is assigned another one of said states.

15. A development tool according to claim 1, comprising owner allocation functionality for allocating an owner to each document type instantiation.

16. A development tool according to claim 15, said owner allocation functionality being operable to set for each data processing system a feature of placing an indication of said allocated owner in a document header.

17. A development tool according to claim 1, comprising global document identification functionality operable to set for each data processing system a feature of allocating to each document type instantiation a unique global identifier.

18. A development tool according to claim 17, said global document identification feature comprising functionality to place said unique global identifier for each document type instantiation in a document header.

19. A development tool according to claim 1, comprising current state indication functionality operable to set for each data processing system a feature of placing a current one of said set of states of a document type instantiation in a document header.

20. A development tool according to claim 1, comprising state ordering functionality operable to set for at least one document type a defined order of succession amongst said set of states.

21. A development tool according to claim 1, said state assignment functionality being operable to depend upon external input to an instantiation of a document type.

22. A development tool according to claim 1, said state assignment functionality being operable to depend upon a property of a document type instantiation.

23. A development tool according to claim 1, said state assignment functionality being operable to alter a property of a document type instantiation.

24. A development tool according to claim 1, wherein a document security property is definable via said states.

25. A development tool according to claim 24, wherein each successive state implementation comprises a stage in said document life cycle, and wherein said document security property comprises a requirement for a document type instantiation to acquire at least one digital signature when passing through at least one predetermined stage.

26. A development tool according to claim 25, wherein said digital signature is acquirable from a user.

27. A development tool according to claim 25, wherein said digital signature is acquirable from said data processing system.

28. A development tool according to claim 24, wherein each successive state implementation comprises a stage in said document life cycle, and wherein said document security property comprises a requirement for a document type instantiation to have at least one digital signature from a previous stage before being assigned a state attributable to a new stage.

29. A development tool according to claim 28, wherein said digital signature is acquirable from a user.

30. A development tool according to claim 28, wherein said digital signature is acquirable from said data processing system.

31. A development tool according to claim 24, wherein said document type developer is operable to provide functionality for defining said security property at a document type level.

32. A development tool according to claim 15, wherein said properties definable via said states comprise document access permission.

33. A development tool according to claim 15, wherein said owner is exchangeable with a change in state.

34. A development tool according to claim 1, wherein said properties definable via said states comprise document access permission.

35. A development tool according to claim 34, wherein document access permission is definable for a given user.

36. A development tool according to claim 35, wherein said access comprises deleting a document type instantiation.

37. A development tool according to claim 35, wherein said access comprises reading a document type instantiation.

38. A development tool according to claim 35, wherein said access comprises changing a property of a document type instantiation.

39. A development tool according to claim 1, wherein a component protocol is one of a group of protocols comprising: ActiveX, COM, and COM+.

40. A network based data processing system for processing data arranged in documents, wherein said documents are instantiations of document types obtained from a document type library, said document types having a set of states, each state being definitive of at least one document property, said data processing system having state assignment functionality for assigning to each document successive ones of said set of states and thus applying said respective property to said instantiation, to thereby successively define for each document within said data processing system a succession of properties during a life cycle of said document.

41. A network based data processing system according to claim 40, wherein each of said document types comprises an assembly of predefined object components.

42. A network based data processing system according to claim 40, comprising document type addition functionality for adding a document type to the document type library during data processing system operation.

43. A network based data processing system according to claim 40, wherein each successive state implementation comprises a stage in said document life cycle, and wherein said set of states includes at least one non-persistent state for attributing to document stages that are not to be saved within the data processing system.

44. A network based data processing system according to claim 43, wherein said at least one non-persistent state is attributable to a document outgoing stage.

45. A network based data processing system according to claim 44, wherein a persistent state is alternately attributable to a document outgoing stage that is to be saved within the data processing system.

46. A network based data processing system according to claim 45, said persistent state being effective to cause generation of said outgoing stage to be delayed.

47. A network based data processing system according to claim 46, wherein said delay is set to depend on system load.

48. A network based data processing system according to claim 40, wherein said set of states includes at least one initiating state for assigning to a document during creation of said document.

49. A network based data processing system according to claim 40, operable to place a document type indicator in a document header.

50. A network based data processing system according to claim 40, wherein at least one of said states has a property of check-in check-out control, to restrict editing level access to a single user at any one time.

51. A network based data processing system according to claim 50, wherein said check-in check-out control comprises a time limitation for any given user.

52. A network based data processing system according to claim 40, operable to set for each data processing system a feature of prompting for saving document history each time any document is assigned another one of said states.

53. A network based data processing system according to claim 40, operable to set for a document type a feature of saving document history each time an instantiation of said document type is assigned another one of said states.

54. A network based data processing system according to claim 40, operable to set for a document a feature of saving document history each time said document is assigned another one of said states.

55. A network based data processing system according to claim 40, comprising owner allocation functionality for allocating an owner to each document.

56. A network based data processing system according to claim 43, said owner allocation functionality being operable to set a feature of placing an indication of said allocated owner in a document header.

57. A network based data processing system according to claim 40, comprising global document identification functionality operable to set a feature of allocating to each document a unique global identifier.

58. A network based data processing system according to claim 57, wherein said global document identification feature is operable to place said unique global identifier for each document in a document header.

59. A network based data processing system according to claim 40, comprising current state indication functionality for setting a feature of placing a current one of said set of states of a document in a document header.

60. A network based data processing system according to claim 40, comprising state ordering functionality for setting for at least one document type a defined order of succession amongst said set of states.

61. A network based data processing system according to claim 40, said state assignment functionality being operable to accept external input to affect assignment of said states.

62. A network based data processing system according to claim 40, said state assignment functionality being operable to affect assignment of said states in accordance with a property of a document.

63. A network based data processing system according to claim 40, said state assignment functionality being operable to alter a property of a document.

64. A network based data processing system according to claim 40, wherein a document security property is definable via said states.

65. A network based data processing system according to claim 64, wherein each successive state implementation comprises a stage in said document life cycle, and wherein said document security property comprises a requirement for a document to acquire at least one digital signature when passing through at least one predetermined stage.

66. A network based data processing system according to claim 65, wherein said digital signature is acquirable from a user.

67. A network based data processing system according to claim 65, wherein said digital signature is acquirable from said data processing system.

68. A network based data processing system according to claim 64, wherein each successive state implementation comprises a stage in said document life cycle, and wherein said document security property comprises a requirement for a document to have at least one digital signature from a previous stage before being assigned a state corresponding to a new stage.

69. A network based data processing system according to claim 68, wherein said digital signature is acquirable from a user.

70. A network based data processing system according to claim 68, wherein said digital signature is acquirable from said data processing system.

71. A network based data processing system according to claim 64, wherein said data processing system is operable to provide functionality for defining said security property at a document type level.

72. A network based data processing system according to claim 55, wherein a property definable via said states comprises document access permission.

73. A network based data processing system according to claim 55, wherein said owner is exchangeable with a change in state.

74. A network based data processing system according to claim 40, wherein a property definable via said states comprises document access permission.

75. A network based data processing system according to claim 74, wherein document access permission is definable for a given user.

76. A network based data processing system according to claim 75, wherein said access permission comprises permission to delete a document.

77. A network based data processing system according to claim 75, wherein said access permission comprises permission to read a document.

78. A network based data processing system according to claim 75, wherein said access permission comprises permission to change a property of a document.

79. A network based data processing system according to claim 40, wherein a document comprises a header for recording the type and state of said document, and a body for recording additional properties.

80. A network based data processing system according to claim 79, wherein a document further comprises a signature section for recording at least one digital signature.

81. A network based data processing system according to claim 79, wherein a document further comprises a history section for recording document history.

82. A network based data processing system according to claim 79, wherein a document further comprises a relationships section for recording at least one reference to another document.

83. A network based data processing system according to claim 40, wherein a document is presented in one of a group of formats comprising: text, XML, SGML, HTML, dynamic HTML, and VRML.

84. A network based data processing system according to claim 40, wherein said data processing system further comprises a kernel having functionality for providing access to said documents through a standard interface.

85. A network based data processing system according to claim 84, wherein said kernel is operable to provide said access to said documents through said standard interface by receiving an external call to said document through said standard interface, determining a document type of said document, transforming said external call into a call appropriate to said document type, and forwarding said converted call to said document.

86. A network based data processing system according to claim 84, wherein a protocol of said external call to said kernel includes one of a group comprising: web service protocols, SOAP, DCOM, HTTP, and HTTPS.

87. A network based data processing system according to claim 40, wherein said data processing system further comprises a runtime environment having functionality for providing runtime services for controlling and monitoring said data processing system.

88. A method of providing a development tool for a network based data processing system, the method comprising:
providing a component data store comprising a plurality of object components; and,
providing a document type developer for assembling document types from said object components and for associating with each a set of states, each state being definitive of at least one document property, said document types being usable to instantiate documents to form a data processing system, said document types being usable with a data processing system having state assignment functionality for assigning to each instantiation successive ones of said set of states and thus applying said respective property to said instantiation, to thereby successively define for said document type instantiation within said data processing system a succession of properties during a life cycle of said document type instantiation.

89. A method of providing a development tool for a network based data processing system according to claim 88, wherein a protocol of an object component is one of a group of protocols comprising: ActiveX, COM, and COM+.

90. A method of providing a development tool for a network based data processing system according to claim 88, further comprising providing a code inserter for attaching application specific code to said object components.

91. A method of providing a development tool for a network based data processing system according to claim 88, wherein providing a document type developer further comprises providing a code generator for generating application specific code from a set of data provided by a data processing system developer.

92. A method of providing a development tool for a network based data processing system according to claim 88, wherein said c ode conforms to a coding standard.

93. A method of providing a development tool for a network based data processing system according to claim 88, wherein said code conforms to a naming convention.

94. A method of developing a data processing system, the method comprising:
generating document types from prestored object components; and,
associating with each document type a set of states, each state being definitive of at least one document property, said document types being usable to instantiate documents to form a data processing system having state assignment functionality for assigning to said document type instantiation successive ones of said set of states and thus applying said respective property to said document type instantiation, to thereby successively define for said document type instantiation within said data processing system a succession of properties during a life cycle of said document type instantiation.

95. A method of developing a data processing system according to claim 94, wherein assembling a document type from prestored object components comprises:
inserting application specific code into an object component thereby creating an application component; and,
combining said application component with at least one other component thereby to form an application specific document type.

96. A method of developing a data processing system according to claim 94, wherein assembling a document type further comprises:
defining a set of transitions between pairs of states from said set of states;
defining a set of transition rules comprising at least one transition rule for each of said transitions, said transition rule identifying a condition at which an instantiation of said document type undergoes said transition; and,
associating said set of transitions and said set of transition rules with said document type;
thereby to define a legal succession of properties during a life cycle of a document type instantiation.

97. A method of developing a data processing system according to claim 94, wherein said condition comprises receiving a predetermined external input to a document type instantiation.

98. A method of developing a data processing system according to claim 94, wherein said condition comprises a property of a document type instantiation equaling a predetermined value.

99. A method of developing a data processing system according to claim 96, wherein defining said set of transition rules comprises defining an order of said set of states.

100. A method of developing a data processing system according to claim 96, wherein each successive state implementation comprises a stage in said document life cycle, and wherein a transition rule comprises a requirement for a document type instantiation to acquire at least one digital signature when passing through a respective stage.

101. A method of developing a data processing system according to claim 100, wherein said digital signature is acquirable from a user.

102. A method of developing a data processing system according to claim 100, wherein said digital signature is acquirable from said data processing system.

103. A method of developing a data processing system according to claim 94, wherein each successive state implementation comprises a stage in said document life cycle, and wherein said set of states includes at least one non-persistent state for attributing to document type instantiation stages that are not to be saved within the data processing system.

104. A method of developing a data processing system according to claim 103, wherein said at least one non-persistent state is attributable to a document type instantiation outgoing stage.

105. A method of developing a data processing system according to claim 104, wherein a persistent state is alternately attributable to a document type instantiation outgoing stage that is to be saved within the data processing system.

106. A method of developing a data processing system according to claim 105, said persistent state being effective to cause generation of said outgoing stage to be delayed.

107. A method of developing a data processing system according to claim 106, wherein said delay is set to depend on system load.

108. A method of defining the processing of a document in a data processing system having state assignment functionality, said document comprising an instantiation of a document type, said document type having a set of states, each state being, definitive of at least one document property, for assigning to said document successive ones of said set of states and thus applying said respective property to said document, to thereby successively define for said document a succession of properties during a life cycle of said document, said method comprising:
defining a set of transitions between pairs of states from said set of states;
defining a set of transition rules comprising at least one transition rule for each of said transitions, said transition rule identifying a condition at which an instantiation of said document type undergoes said transition; and,
associating said set of transitions and said set of transition rules with said document type.

109. A method of defining the processing of a document in a data processing system having state assignment functionality according to claim 108, wherein said condition comprises an external input to a document type instantiation.

110. A method of defining the processing of a document in a data processing system having state assignment functionality according to claim 108, said wherein said condition comprises a property of a document type instantiation.

111. A method of defining the processing of a document in a data processing system having state assignment functionality according to claim 108, wherein said defining a set of transition rules comprises defining an order of said set of states.

112. A method of defining the processing of a document in a data processing system having state assignment functionality according to claim 108, wherein each successive state implementation comprises a stage in said document life cycle, and wherein a transition rule comprises a requirement for a document type instantiation to acquire at least one digital signature when passing through a respective stage.

113. A method of defining the processing of a document in a data processing system having state assignment functionality according to claim 112, wherein said digital signature is acquirable from a user.

114. A method of defining the processing of a document in a data processing system having state assignment functionality according to claim 112, wherein said digital signature is acquirable from said data processing system.

115. A method of defining the processing of a document in a data processing system having state assignment functionality according to claim 108, wherein each successive state implementation comprises a stage in said document life cycle, and wherein said set of states includes at least one non-persistent state for assigning to document type instantiation stages that are not to be saved within the data processing system.

116. A method of defining the processing of a document in a data processing system having state assignment functionality according to claim 115, wherein said at least one non-persistent state is assignable to a document type instantiation outgoing stage.

117. A method of defining the processing of a document in a data processing system having state assignment functionality according to claim 116, wherein a persistent state is alternately assignable to a document type instantiation outgoing stage that is to be saved within the data processing system.

118. A method of defining the processing of a document in a data processing system having state assignment functionality according to claim 117, said persistent state being effective to cause generation of said outgoing stage to be delayed.

119. A method of defining the processing of a document in a data processing system having state assignment functionality according to claim 108, further comprising providing external access to a document through a standard interface by:
receiving a call to a document through said standard interface;
determining a document type of said document;
converting said external call into a call that uses a protocol appropriate to said document type; and,
forwarding said converted call to said document.
